(19) United States
(12) Patent Application Publication
(10) Pub. No.: US 2022/0237563 A1
(43) Pub. Date: Jul. 28, 2022

(54) SYSTEM AND METHOD FOR APPRAISING DAMAGE CLAIMS

(71) Applicant: MASTER PLUMBING CORPORATION, San Diego, CA (US)

(72) Inventor: Michael S. Logsdon, SR., San Diego, CA (US)

(21) Appl. No.: 17/157,417

(22) Filed: Jan. 25, 2021

(51) Int. Cl. G06Q 10/10; G06Q 50/26

(52) U.S. Cl. CPC G06Q 10/10; G06Q 50/26

(57) ABSTRACT

A system and method for processing an insurance claim for property damages suffered by a claimant, first requires a field investigation to collect information. This information includes a property description, maps, sketches and photographs of damage to the property and supporting documentation. In-house personnel of the insurance carrier then factorize the information to identify a probable cause and an origin of the damages. If it is determined the property damages are an unexpected loss, the resultant factors are coalesced into a cause and origin report for further use in appraising the claim. In accordance with the present invention, all actions for creating the ultimate appraisal are performed by in-house personnel.

### FIELD OF THE INVENTION

The present invention pertains generally to methods and procedures for the in-house processing of insurance claims for property damage. More particularly, the present invention pertains to in-house processing procedures wherein employees of an insurance carrier are dispatched by the carrier to gather the information and documents needed to characterize the nature, extent, and probable cause of the property damage. The present invention is particularly, but not exclusively, useful as a method and procedure for processing insurance claims using exclusively in-house employees of the insurance carrier to appraise property damage.

### BACKGROUND OF THE INVENTION

Heretofore, insurance claims for property damages have been processed, in part, using field and independent adjusters. From the perspective of the insurance carrier, the process has frequently been time consuming, and not always directed to the legitimate concerns of the carrier. Furthermore, control over a process where field and independent adjusters are involved has often been tenuous. This diminished control is all the more problematic when it is recognized that the evaluation and assessment of the data ultimately required to make an appraisal of the damages is directly dependent on the accurate, complete and timely collection of relevant data.

In recent years, data collection devices have been developed to the point where data that is pertinent to an evaluation of property damages can be effectively collected and evaluated very efficiently and accurately. Importantly, data collection and evaluation functions are not labor-intensive, and they can be performed using well known techniques and devices. For example, 3D cameras that can effectively visualize a property damages site are commercially available from manufacturers such as “Matterport”. Further, insurance claims estimating software is also available from commercial entities such as “Xactimate”. With such tools, a direct coordination of in-house adjustors with other in-house personnel who gather, collect and organize the physical, administrative and regulatory documentation needed to prepare a comprehensive appraisal of property damages, simplifies control and enhances efficiency.

In light of the above, it is an object of the present invention to process an insurance claim quickly and efficiently using only employees of the insurance carrier. Another object of the present invention is to maintain direct operational control over the gathering of all information that is needed to prepare a comprehensive appraisal for a damage claim. Yet another object of the present invention is to provide a methodology for efficiently winnowing and coalescing both cause and effect factors for an appraisal of actual property damages in a timely manner, that is comprehensive, accurate and fair for the claimant. Still another object of the present invention is to provide a methodology for preparing an appraisal for property damages that is easy to implement, is simple to use, and is cost effective.

### SUMMARY OF THE INVENTION

In accordance with the present invention, a method is provided for use by an insurance carrier to process an insurance claim completely in-house. In response to a claim, the first step in the methodology of the present invention is to dispatch an investigator to the site where the property damages have allegedly occurred. Gathering information at the site that is pertinent for an evaluation of the damaged property requires making an initial estimate of the extent of property damage. Also, information that is helpful for identifying the relevant cause and effect factors needed to initially determine whether property damage at the site was an unexpected loss can be collected.

In detail, the information to be gathered during a field investigation will include a detailed property description, e.g. i) personal residence(s), ii) buildings and edifices, iii) vehicle(s), iv) conveyances, and v) infrastructures. Additionally, information gathering at the site will also require identifying the age, condition, extent, and relative location of the damaged property at the site. Also, information pertaining to the cause of the property damage, i.e. i) fire, ii) water, iii) explosion, iv) impulse forces, and v) other cause(s) with an appropriate description are needed. In general, the nature and extent of damage can be recorded by taking in-situ photos, preparing sketches and maps, and obtaining claimant and witness comments regarding incidents and recollections before and after the property damage.

Once on-site data has been collected, it is next necessary to establish a firm estimate of the extent of property damage at the site, and to evaluate the information to identify the relevant cause and effect factors for the property damage. This evaluation will typically also include i) reviewing police records and reports, ii) considering claimant and witness comments, iii) analyzing pertinent financial information, and iv) referencing relevant documentary evidence.

An important function in the methodology of the present invention is to factorize the collected data into cause and effect factors. The cause and effect factors are then respectively winnowed to discard nonessential factors and to focus on the pertinent factors that are necessary for determining a probable cause for the property damage (cause factors) and for determining the resultant effect(s) of the causation (effect factors). In this process, the cause factors are evaluated by considering the nature of actual damages to identify a most probable cause for the damages. Additionally, the effect factors are assessed by considering the nature of the actual damages to determine an origin of the actual damages during this process. Together the result is a cause and origin report which will be used to substantiate whether the property damage is an unexpected loss.

In the process of preparing an appraisal report for implementing a proposed course of action by the insurance carrier to settle the claim, it may be necessary to review previously archived reports that may be pertinent to the damaged property, client profile information, and causation and origin factors. The present invention envisions that a computer may be helpful for this purpose. Also, a computer may be helpful for coalescing data factors into cause and effect categories for evaluating the insurance claim in the appraising step. Once the appraisal has been completed it is preferable that a copy of the appraisal report be placed in an archives for future reference.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a flow chart showing the steps taken by an insurance carrier for an in-house processing of an insurance claim; and

FIG. 2 is a functional flow chart showing computerized tasks to be accomplished for converting field data into documentation for a subsequent property damage appraisal.

### DESCRIPTION OF THE PREFERRED EMBODIMENTS

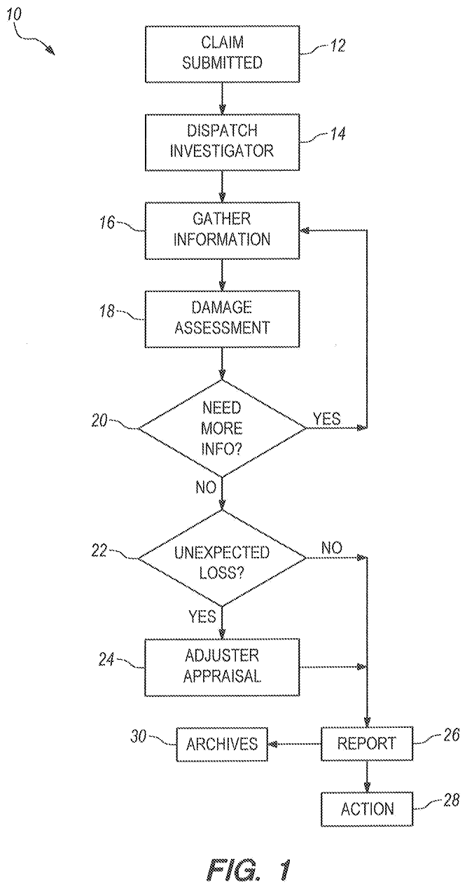

Referring initially to FIG. 1 a method for the in-house processing of an insurance claim for property damage is shown and is generally designated 10. As shown, the method 10 begins when a claim is submitted to the insurance carrier (see block 12). The first affirmative step for the insurance carrier is to then dispatch personnel to the field site where the alleged damage has occurred (see block 14). At the field site, an investigator(s) will gather information that is pertinent for an evaluation of the damage (see block 16). In detail, this information gathering step (block 16) will include identifying an age, condition, extent, and relative location of the damaged property at the site. It will also include recording the nature and extent of damage; taking in-situ photos; preparing sketches; and recording claimant and witness comments regarding incidents and recollections before and after the property damage.

Along with the information gathered at the field site (block 16), the method 10 further requires an off-site assessment/evaluation of the damage. Additional information for this purpose can be obtained from sources beyond the field, such as reviewing police records and reports, considering claimant and witness comments, analyzing pertinent financial information, and referencing relevant documentary evidence. Further, it may be necessary to review previously archived reports pertinent to the damaged property, client profile information, causation and origin factors, as well as specific information that may be deemed pertinent.

Once all of the acquired information has been assessed (see block 18) the inquiry block 20 requires a determination as to whether additional information is needed, i.e. return to block 16. If not, inquiry block 22 requires a determination as to whether the damage was an unexpected loss. If the determination is that the loss was unexpected, there is a need for an adjuster appraisal (block 24) and a consequent report supporting the appraisal (see block 26). On the other hand, if the loss should have been expected or avoided by reasonable conduct by the claimant, the report 26 will provide reasons for denying the claim. In any event, all of the above tasks can be accomplished using in-house employees of the insurance carrier. Accordingly, action is taken (see block 28) and a report of the investigation is given which informs the claimant of the action being taken by the insurance carrier; to either pay or deny the claim. As a final action on the claim, the report should be archived for possible future use (see block 30).

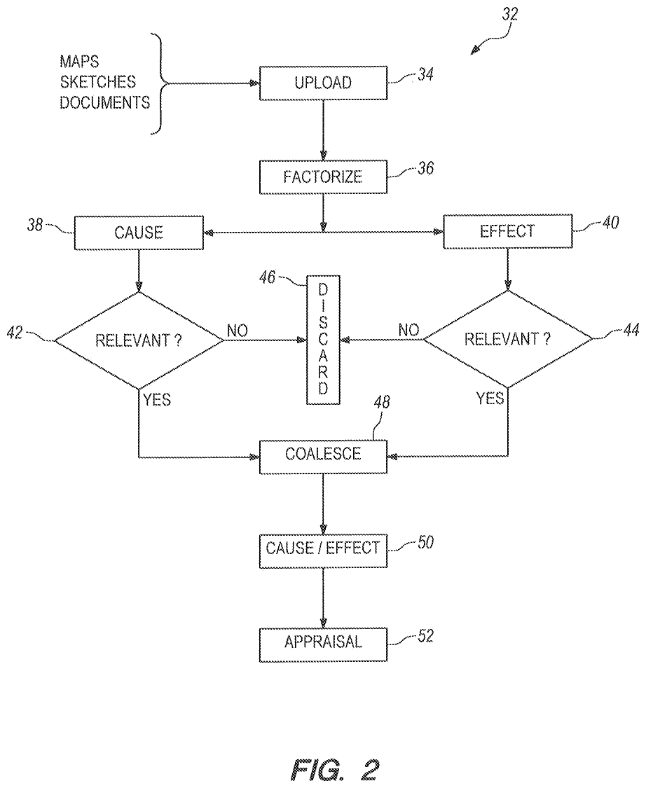

As envisioned by the present invention, as shown in FIG. 2, a process 32 for evaluating and appraising a valid claim can be facilitated and simplified by employing a computer (not shown). Specifically, (block 16) for the information gathering step, (block 22) for the determination as to whether the damage was an unexpected loss, and (block 24) for portions of the adjuster appraisal itself, can all be aided by the use of a computerized process 32.

In FIG. 2 it is to be appreciated that damage information, together with other administrative and pertinent information, can all be uploaded for computerized processing (block 34). For example, an administrative input including claimant identification, property ownership rights, and property location may be required. Also, set-up input may be required such as the selection of a probable cause for the property damage, to include indicators of i) fire, ii) water, iii) explosion, iv) impulse forces, and v) other cause(s) with an appropriate description. Further, a property description input may be helpful which identifies i) personal residence(s), ii) buildings and edifices, iii) vehicle(s), iv) conveyances, v) infrastructures, vi) and other descriptions for structures of interest. Still further, it may be preferable to include field investigation information that was obtained during the gathering step regarding i) documentation, ii) photos, and iii) maps and sketches.

Once the pertinent information has been uploaded (block 34) the method/process 10/32 of the present invention envisions a winnowing of the information to discard nonessential and redundant factors, and to focus instead on the relevant and pertinent factors necessary for an appraisal. Specifically, the import here is to focus on information that is helpful for determining a probable cause for the property damage, and the resultant effect(s) of the causation.

In accordance with the method/process 10/32 of the present invention, all information to be considered is factorized (see block 36) into cause factors (block 38) and effect factors (block 40). These factors can then be respectively evaluated by the inquiry blocks 42 and 44 according to their relevance. As shown, the factors that are deemed irrelevant or redundant are discarded (block 46). On the other hand, relevant and non-redundant factors are further coalesced (see block 48) into determination of the cause and effect (see block 50) for use in an appraisal (block 52). The result then is a report 26 as shown in FIG. 1, and an archiving of the report 26.

While the particular System and Method for Appraising Damage Claims as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A method for use by an insurance carrier for in-house processing an insurance claim, the method comprising the steps of:
receiving a claim from a claimant for property damages suffered by the claimant under terms of an insurance policy;
dispatching an investigator to a site where the property damages allegedly occurred;
gathering information pertinent to the site where the damage occurred, and information pertinent to damaged property at the site;
estimating an extent of property damage at the site;
evaluating the gathered information to identify relevant cause and effect factors affecting the property damage;
characterizing the nature and probable cause of the property damage at the site as an unexpected loss, based on results of the gathering, estimating, and evaluating steps;
appraising a value for the property damage as an unexpected loss based on determinations made pursuant to the estimating, evaluating and characterizing steps;
preparing an appraisal report for implementing a proposed course of action by the insurance carrier to settle the customer's claim; and
placing the appraisal report in an archives for future reference.

2. The method of claim 1 further comprising the step of repeating the gathering step, as needed, to complete the characterizing step.

3. The method of claim 1 wherein the information gathering step comprises the steps of:
identifying an age, condition, extent, and relative location of the damaged property at the site;
recording the nature and extent of damage;
taking in-situ photos;
preparing sketches; and
recording claimant and witness comments regarding incidents and recollections before and after the property damage.

4. The method of claim 1 wherein the evaluating step includes i) reviewing police records and reports, ii) considering claimant and witness comments, iii) analyzing pertinent financial information, and iv) referencing relevant documentary evidence.

5. The method of claim 1 wherein the characterizing step further comprises the steps of reviewing i) previously archived reports pertinent to the damaged property, ii) client profile information, and iii) causation and origin factors.

6. The method of claim 1 further comprising the step of winnowing the information obtained in the gathering step to discard nonessential factors and to focus on pertinent factors necessary for determining a probable cause for the property damage and the resultant effect(s) of the causation to determine whether the property damage is an unexpected loss.

7. The method of claim 6 further comprising a computer for coalescing factors into cause and effect categories for evaluating the insurance claim in the appraising step.

8. The method of claim 7 further comprising the step of selecting inputs for a computer operation including:
an administrative input requiring i) claimant identification, ii) property ownership rights, and iii) property location;
a set-up input requiring selection of a probable cause of the property damage to include i) fire, ii) water, iii) explosion, iv) impulse forces, and v) other cause(s) with an appropriate description;
a property description input requiring selection of i) personal residence(s), ii) buildings and edifices, iii) vehicle(s), iv) conveyances, v) infrastructures, and vi) other property interests with an appropriate description; and
field investigation information input obtained during the gathering step, to include i) documentation, ii) photos, and iii) maps and sketches.

9. A computer for use in implementing a method for an in-house processing of an insurance claim for property damage suffered by a claimant, the computer comprising:
an input port for downloading i) administrative information and documentation pertinent to the insurance claim, ii) an identification of probable causation for the property damage, iii) a property description, and iv) relevant information gathered during a field investigation;
a component for performing a winnowing function on the input downloaded information to discard nonessential and redundant factors gathered during the field investigation and to focus on pertinent factors necessary for determining an exact cause for the property damage, and the extent of resultant effect(s) of the causation to determine whether the property damage is an unexpected loss; and
a categorizing function for coalescing factors into a comprehensive cause and effect category for evaluating the insurance claim.

10. The computer of claim 9 wherein the administrative information pertinent to the insurance claim includes: i) claimant identification, ii) property ownership rights, and iii) property location.

11. The computer of claim 9 wherein a probable cause of the property damage is selected from a group including: i) fire, ii) water, iii) explosion, iv) impulse forces, and v) other cause(s) with an appropriate description.

12. The computer of claim 9 wherein a property description is selected from a group including: i) a personal residence(s), ii) buildings and edifices, iii) vehicle(s), iv) conveyances, v) infrastructures, and vi) other property interests with an appropriate description.

13. The computer of claim 9 wherein information obtained during the field inspection includes: i) documentation, ii) photos, and iii) maps and sketches.

14. A non-transitory, computer-readable medium having executable instructions stored thereon that direct a computer system to perform in-house processing an insurance claim, the medium comprising instructions for:
downloading data collected during a field investigation of a site location identified by a claimant for property damages in an insurance claim;
winnowing the data to identify cause factors and effect factors relevant to a cause/effect determination for property damages at the site, and to discard non-relevant data therefrom; and
coalescing the relevant factors into a cause/effect determination for appraisal.

15. The computer-readable medium of claim 14 wherein the winnowing step comprises the steps of:
factorizing the collected data into cause factors and effect factors;
evaluating the cause factors and the nature of actual damages to identify a most probable cause for the damages; and
assessing the effect factors and the nature of the actual damages to determine an origin of the actual damages.

16. The computer-readable medium of claim 15 where in the coalescing step results in a cause and origin report for further use in appraising the claim.

17. The computer-readable medium of claim 14 wherein data obtained during the field inspection includes: i) documentation, ii) photos, and iii) maps and sketches.

18. The computer-readable medium of claim 14 wherein cause factors of the property damage are selected from a group including: i) fire, ii) water, iii) explosion, iv) impulse forces, and v) other cause(s) with an appropriate description.

19. The computer-readable medium of claim 14 wherein actual damages are related to property descriptions including: i) a personal residence(s), ii) buildings and edifices, iii) vehicle(s), iv) conveyances, v) infrastructures, and vi) other property interests with an appropriate description.

20. The computer-readable medium of claim 14 wherein the administrative information pertinent to the insurance claim includes: i) claimant identification, ii) property ownership rights, and iii) property location.
